(19) United States
(12) Patent Application Publication
(10) Pub. No.: US 2026/0087163 A1
(43) Pub. Date: Mar. 26, 2026

(54) AUTOMATED DATA SECURITY IDENTIFICATION

(71) Applicant: Motorola Mobility LLC, Chicago, IL (US)

(72) Inventors: Amit Kumar Agrawal, Bangalore (IN); Krishnan Raghavan, Bangalore (IN)

(73) Assignee: Motorola Mobility LLC, Chicago, IL (US)

(21) Appl. No.: 18/898,280

(22) Filed: Sep. 26, 2024

(51) Int. Cl. G06F 21/62; G06F 8/61

(52) U.S. Cl. CPC G06F 21/6218; G06F 8/61

(57) ABSTRACT

Techniques for automated data security identification are described. For instance, a first data security policy corresponding to a first application is obtained, and a second application that is similar to the first application is automatically identified. A second data security policy corresponding to the second application is obtained, and, using at least one machine learning model, a risk differentiation between the first data security policy and the second data security policy is automatically identified and displayed.

### BACKGROUND

In today's digital age, privacy has become a major concern for users. With the growth of technology, the collection, storage, and utilization of personal data has become intrinsic to businesses across industries. This data is used, for example, for targeted marketing, personalized services, improved user experiences, and so forth. However, despite the advantages this data use may have for users, many users remain concerned about how their data may be used.

### BRIEF DESCRIPTION OF THE DRAWINGS

Embodiments of automated data security identification are described with reference to the following drawings. The same numbers are used throughout the drawings to reference like features and components:

FIG. 1 illustrates an example environment in which aspects of automated data security identification can be implemented.

FIG. 2 illustrates a system for implementing aspects of automated data security identification in accordance with aspects of the present disclosure.

FIG. 3 illustrates examples of application data security policy summaries in accordance with aspects of the present disclosure.

FIG. 4 illustrates an example of differences between privacy policies in accordance with aspects of the present disclosure.

FIG. 5 illustrates an example of a risk differentiation in accordance with aspects of the present disclosure.

FIG. 6 illustrates an example of an alert in accordance with aspects of the present disclosure.

FIG. 7 illustrates a flow chart depicting an example method for performing the techniques discussed herein.

FIG. 8 illustrates various components of an example electronic device that can implement embodiments of the techniques discussed herein.

### DETAILED DESCRIPTION

Applications oftentimes have associated privacy policies that describe the manner in which data or information about the user is collected, stored, used, and so forth. One issue with such privacy policies is that they are oftentimes laden with legal jargon, leading to two common outcomes: users consent to the privacy policies without review, or opt to abstain from using the application due to uncertainty about the implications. Thus, users who accept privacy policies without scrutiny risk compromising their privacy, while cautious individuals might forego potentially beneficial services, impacting their digital experiences.

In accordance with the techniques discussed herein, when a target application is to be first used by a user (e.g., due to the application being first run on or downloaded to an electronic device, or being first accessed by the user), the data security policy of the target application is automatically obtained and analyzed. Similarly, at least one additional application (e.g., e.g., an application offering similar functionality as the target application) is identified and the data security policy of the at least one additional application is automatically obtained and summarized. The data security policy of the target application is compared and/or contrasted with the data security policy of the at least one additional application, and a risk summary is generated indicating how the privacy policies of the target application and the at least one additional application differ. This risk summary is presented (e.g., displayed) to the user of the electronic device, allowing the user to make an educated decision on whether to install or otherwise use the target application.

Accordingly, the techniques discussed herein improve the security of the user's data by automatically identifying differences between the privacy policies of different applications and presenting those to the user. Uses of the data that pose a security risk to the user can be identified and an indication of these risks displayed to the user. Additionally, highlighting discrepancies and simplifying complex terms in the privacy policies can empower users with a clearer understanding of how their data is handled, leading to more informed decisions by the users.

Various aspects of implementations described herein can leverage artificial intelligence (AI) functionality (e.g., AI and/or machine learning algorithms, AI and/or machine learning models, etc.) to detect user appearance variations and to generate modified user appearance. As discussed herein, the terms “AI” and “machine learning” can be used to refer to machine-implemented intelligence for performing various tasks on data, such as data analysis, data classification, data modification, data generation, etc. For instance, AI functionality can be used for generating application data security policy summaries or determining differences between privacy policies of different applications. The described implementations can utilize different types of AI models, such as classifier models, generative models, prediction models, combinations thereof, etc.

While features and concepts of automated data security identification can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

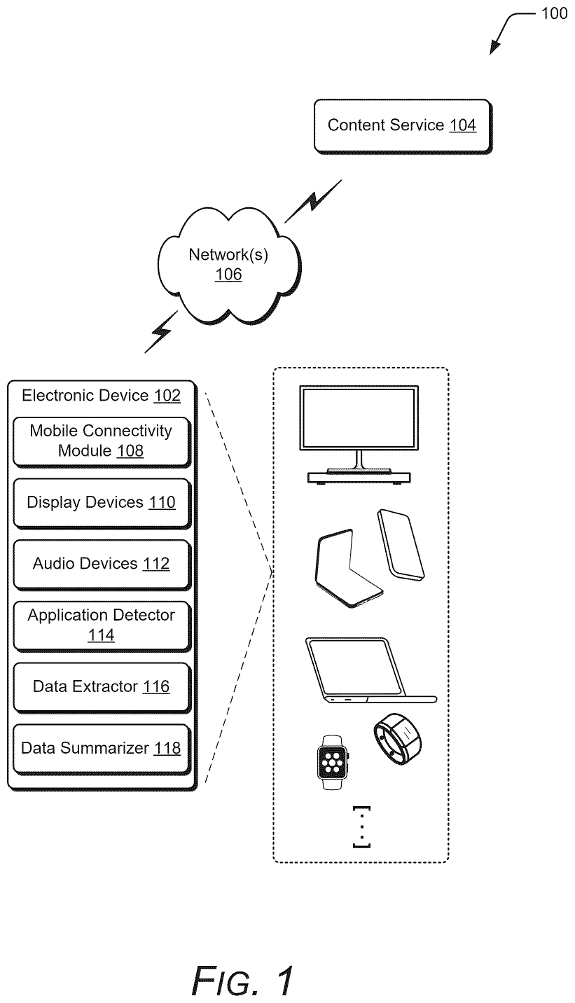

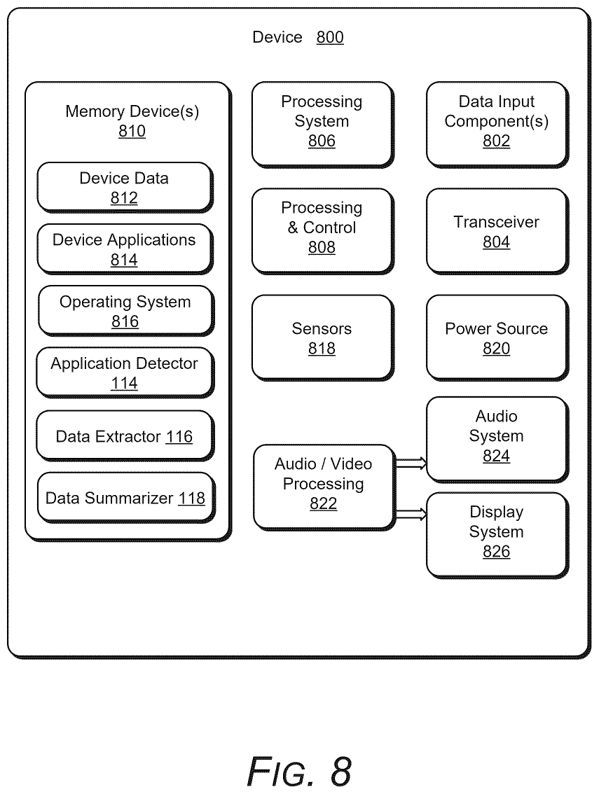

FIG. 1 illustrates an example environment 100 in which aspects of automated data security identification can be implemented. The environment 100 includes an electronic device 102, and a content service 104 that are interconnectable via one or more networks 106. The electronic device 102 can be implemented in various ways, such as a mobile device (e.g., a smartphone), a mobile foldable device (e.g., a foldable smartphone, a foldable tablet device), a laptop computing device, a desktop computing device, a wearable device (e.g., a smartwatch, an augmented reality headset or device, a virtual reality headset or device), an entertainment device (e.g., a gaming console, a portable gaming device, a streaming media player, a digital video recorder, a music or other audio playback device), a video camera, an Internet of Things (IoT) device, an automotive computer, and so forth. Example attributes of the electronic device 102 are discussed below with reference to the device 800 of FIG. 8.

The electronic device 102 includes various functionality that enables the electronic device 102 to perform different aspects of automated data security identification discussed herein, including a mobile connectivity module 108, display devices 110, audio devices 112, an application detector 114, a data extractor 116, and a data summarizer 118. The mobile connectivity module 108 represents functionality (e.g., logic and hardware) for enabling the electronic device 102 to interconnect with other devices and/or networks, such as the network 106. The mobile connectivity module 108, for instance, enables wireless and/or wired connectivity of the electronic device 102.

The display devices 110 represent functionality for outputting visual content via the electronic device 102. The electronic device 102 includes one or more display devices 110 that can be leveraged for outputting content. The audio devices 112 represent functionality for providing audio output for the electronic device 102. In at least one implementation the electronic device 102 includes audio devices 112 positioned at different regions of the electronic device 102, such as to provide for different audio output scenarios.

Each of the application detector 114, the data extractor 116, and the data summarizer 118 can be implemented in a variety of different manners. For example, each of the application detector 114, the data extractor 116, and the data summarizer 118 can be implemented as multiple instructions stored on computer-readable storage media and that can be executed by a processing system (e.g., one or more processors). Additionally or alternatively, each of the application detector 114, the data extractor 116, and the data summarizer 118 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). One or more of the application detector 114, the data extractor 116, and the data summarizer 118 can be implemented in the same manner, or the application detector 114, the data extractor 116, and the data summarizer 118 can each be implemented in a different manner. Furthermore, one or more of the application detector 114, the data extractor 116, and the data summarizer 118 can be implemented at least in part as part of an operating system of the electronic device 102.

The application detector 114 represents functionality to detect or identify an application being accessed or requested (e.g., by a user of the electronic device 102). The application detector 114 also represents functionality to detect or identify at least one additional application that is similar to the application or web service being accessed or requested. The data extractor 116 represents functionality to extract data security policies from the applications identified or detected by the application detector 114. A data security policy is also referred to herein as a privacy policy.

The data summarizer 118 represents functionality to identify, based at least in part on the data security policies extracted by the data extractor 116, one or both of at least one similarity or at least one difference between the data security policies identified or detected by the application detector 114. The data summarizer 118 can also display or otherwise present the at least one similarity or the at least one difference, or a summary of the similarities or differences, to a user of the electronic device 102 (e.g., on one of the display devices 110).

As described above, different operations of the application detector 114, the data extractor 116, and/or the data summarizer 118 can be performed using AI functionality, such as one or more AI classifier models for detecting or identifying an additional application, one or more AI generative models for extracting privacy policies, and/or one or more AI generative models for identify one or both of at least one similarity or at least one difference between the identified or detected applications.

Reference is made herein refer to applications. An application refers to a program that is executed or run on an electronic device, such as a program that is run on the electronic device 102 or a program that is run on another device (e.g., on a computer and accessed by the electronic device 102 via the one or more networks 106). A program run on another device may also be referred to as a service or a web service, such as a service or web page accessible to the electronic device 102 via the World Wide Web.

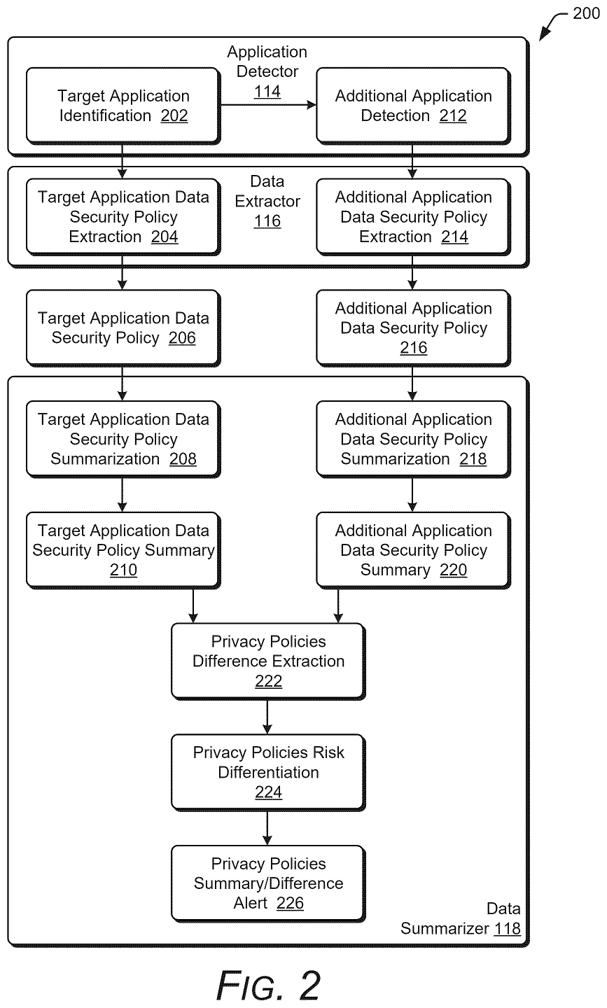

FIG. 2 illustrates a system 200 for implementing aspects of automated data security identification in accordance with aspects of the present disclosure. In the system 200 the application detector 114 identifies or detects 202 a target application. The target application refers to an application that the user of the electronic device 102 desires to use or access, such as an application the user is requesting to run for the first time, download, or install on the electronic device 102.

The data extractor 116 extracts 204 the data security policy 206 for the target application. The data security policy for the target application, also referred to as a privacy policy, describes various privacy protection policies used by the target application, such as the type of data collected by the target application, how the data is collected by the target application, how the data is used by the target application, how long data will be stored by the target application, information about tracking performed by the target application, a confirmation that any third-party service providers (such as analytical or marketing tools) will provide accurate protection of users' data, and the like. The data extractor 116 extracts the data security policy for the target application in any of a variety of different manners, such as retrieves the data security policy from a web site (e.g., application store) associated with the application or receives the data security policy from the application itself.

The data summarizer 118 summarizes 208 the target application data security policy, resulting in a target application data security policy summary 210. In one or more implementations, the data summarizer 118 automatically summarizes the target application data security policy after the data extractor 116 extracts the target application data security policy. Additionally or alternatively, the data summarizer 118 summarizes the target application data security policy in response to a user input requesting summarization or analysis of the target application data security policy.

The target application data security policy summary 210 includes, for example, one or more of an indication of types of personal information or data the target application collects, the manner in which the target application uses the collected information or data, what cookies or types of cookies the target application uses, what security measures the target application uses to protect the collected information or data, what consent or permissions the user is allowing when agreeing to the target application data security policy, and the like.

In one or more implementations, the data summarizer 118 leverages AI functionality to generate the target application data security policy summary 210. For example, the data summarizer 118 uses a machine learning or AI model trained using various different input data security policies to generate a data security policy summarization based on an input data security policy. The machine learning or AI model can be trained, for example, using supervised or unsupervised learning.

The application detector 114 also identifies or detects 212 at least one additional application based at least in part on the target application. Each of the at least one additional application identified by the application detector 114 is an application that is comparable or similar to the target application. Such a comparable or similar application is, for example determined based on functionality (e.g., an application that performs a comparable or similar functionality as the target application, such as digital payment functionality, mapping or navigation functionality, texting or email functionality, image capture or editing functionality, and so forth), location or origin (e.g., an application authored in or a web site hosted in a same country as the electronic device 102 is located in), and the like. The additional application can be identified or detected in various manners, such as based on a category in an application store, based on metadata associated with the applications, and so forth. For example, if the target application is a payment application, the application detector 114 can identify one or more additional applications that are also payment applications (e.g., have the same category, such as “payment”, in an application store).

In one or more implementations, each of the at least one additional application is an application that has been used by the user in the past (e.g., used by a user account of the user) and that has a data security policy that was previously accepted by the user. This can be, for example, an application that is currently installed on the electronic device 102 or that was previously installed on the electronic device 102. This allows the data security policy of the target application to be analyzed with reference to data security policies already or previously accepted by the user of the electronic device 102. Additionally or alternatively, one or more of the at least one additional application is an application that has not been used by the user in the past (e.g., not used by a user account of the user).

The data extractor 116 extracts 214 the data security policy 216 for each of the at least one additional application. The data security policy for an additional application, also referred to as a privacy policy, describes various privacy protection policies used by the additional application, such as the type of data collected by the additional application, how the data is collected by the additional application, how the data is used by the additional application, how long data will be stored by the additional application, information about tracking performed by the additional application, a confirmation that any third-party service providers (such as analytical or marketing tools) will provide accurate protection of users' data, and the like. The data extractor 116 extracts the data security policy for the additional application in any of a variety of different manners, such as retrieves the data security policy from a web site (e.g., application store) associated with the application or receives the data security policy from the application itself.

The data summarizer 118 summarizes 218, for each of the at least one additional application, the additional application data security policy, resulting in a target application data security policy summary 220. In one or more implementations, the data summarizer 118 automatically summarizes the additional application data security policy after the data extractor 116 extracts the target application data security policy. Additionally or alternatively, the data summarizer 118 summarizes the additional application data security policy in response to a user input requesting summarization or analysis of the target application data security policy or the additional application data security policy.

The additional application data security policy summary 220 includes, for example, one or more of an indication of types of personal information or data the additional application collects, the manner in which the additional application uses the collected information or data, what cookies or types of cookies the additional application uses, what security measures the additional application uses to protect the collected information or data, what consent or permissions the user is allowing when agreeing to the additional application data security policy, and the like.

In one or more implementations, the data summarizer 118 leverages AI functionality to generate the additional application data security policy summary 220. For example, the data summarizer 118 uses a machine learning or AI model trained using various different input data security policies to generate a data security policy summarization based on an input data security policy. The machine learning or AI model can be trained, for example, using supervised or unsupervised learning. In one or more implementations, the AI model used to generate the target application data security policy summary 220 is the same AI model as is used to generate the target application data security policy summary 210.

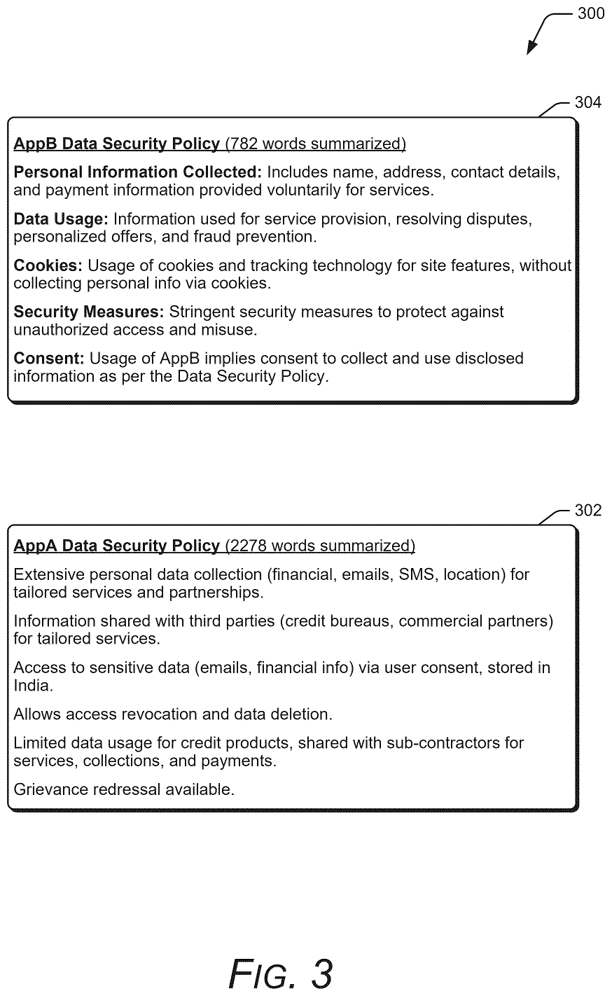

FIG. 3 illustrates examples 300 of application data security policy summaries in accordance with aspects of the present disclosure. The examples 300 include a data security policy summary 302 for one application (illustrated as AppA), and a data security policy summary 304 for another application (illustrated as AppB). In this example, AppA can be the target application and AppB can be an additional application (e.g., that the user of the electronic device 102 has previously used). The data security policy summaries 302 and 304 indicate, for each application AppA and AppB, one or more of types of personal information or data the application collects, the manner in which the application uses the collected information or data, what cookies or types of cookies the application uses, what security measures the application uses to protect the collected information or data, or what consent or permissions the user is allowing when agreeing to the application's data security policy.

Returning to FIG. 2, the data summarizer 118 extracts 222 at least one difference between the target application and each of the at least one additional application. The at least one difference is a difference, from a risk perspective, between the data security policies of the applications and is based at least in part on the data security policy summaries 210 and 220. The at least one difference can be, for example, one or more of a difference in types of personal information or data the applications collect, a difference in the manners in which the applications use the collected information or data, a difference in what cookies or types of cookies the applications use, a difference in what security measures the applications use to protect the collected information or data, a difference in consent or permissions the user is allowing when agreeing to the privacy policies of the applications, and the like.

In one or more implementations, the data summarizer 118 leverages AI functionality to determine at least one difference between the data security policy of the target application and the data security policy of each of the at least one additional application. For example, the data summarizer 118 uses a machine learning or AI model trained to generate a list of one or more differences between the data security policy of the target application and the data security policy of each of the at least one additional application. The machine learning or AI model can be trained, for example, using supervised or unsupervised learning.

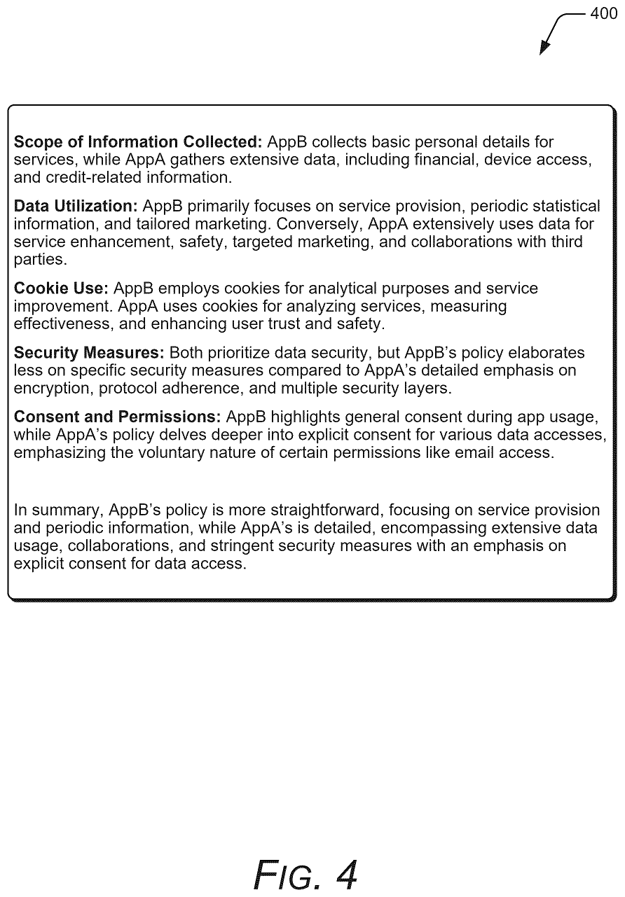

FIG. 4 illustrates an example 400 of differences between privacy policies in accordance with aspects of the present disclosure. The example 400 illustrates differences between the data security policy summary 302 and the data security policy summary 304 of FIG. 3. The example 400 indicates differences between the privacy policies for application AppA and AppB with respect to types of personal information or data the applications collect, the manner in which the applications use the collected information or data, what cookies or types of cookies the applications use, what security measures the applications use to protect the collected information or data, or what consent or permissions the user is allowing when agreeing to the applications' privacy policies. A high-level summary indicating that the data security policy of AppA is more straightforward, focusing on service provision and periodic information, while the data security policy of AppB is detailed, encompassing extensive data usage, collaborations, and stringent security measures with an emphasis on explicit consent for data access.

Returning to FIG. 2, the data summarizer 118 uses the at least one difference between the target application and each of the at least one additional application to generate a risk differentiation 224. The risk differentiation 224 is an indication of the risk of the target application relative to each of the at least one additional application. This indication can take various forms, such as a summary or list of the differences and/or similarities between the differences in the data security policies.

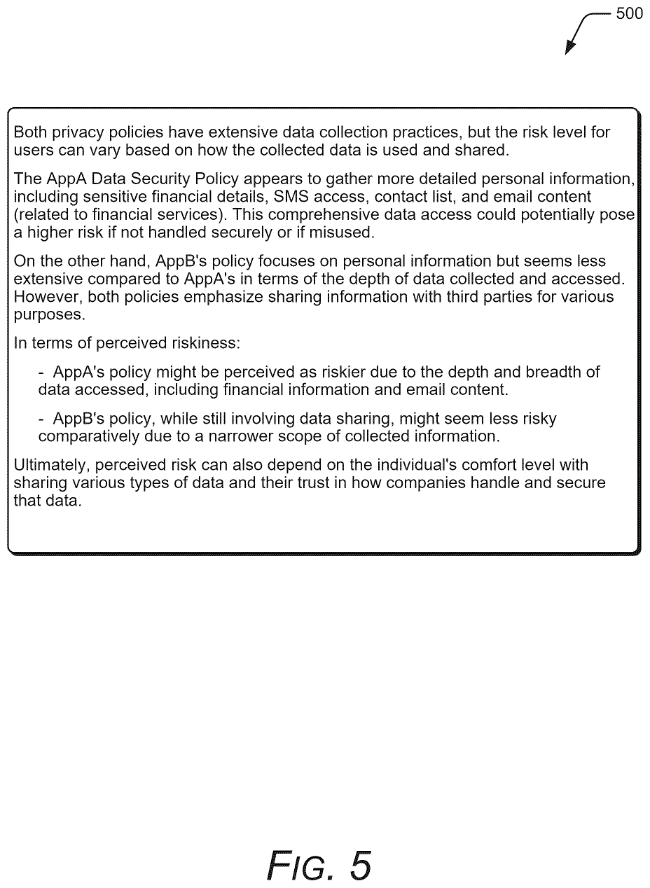

FIG. 5 illustrates an example 500 of a risk differentiation in accordance with aspects of the present disclosure. The example 500 illustrates, with reference to applications AppA and AppB discussed above in FIGS. 3 and 4, differences in the personal information gathered or accessed by applications AppA and AppB, and perceived riskiness, based on their privacy polices, of installing or using application AppA.

Returning to FIG. 2, the data summarizer 118 generates and outputs (e.g., displays or otherwise presents) an alert 226 indicating (e.g., highlighting) the differences and/or similarities between the data security policies of the target application and each of the at least one additional application. This alert allows the user to make an informed choice on whether they want to accept or opt into the data security policy of the target application, or possibly select a different application (e.g., one of the at least one additional application) to use rather than the target application.

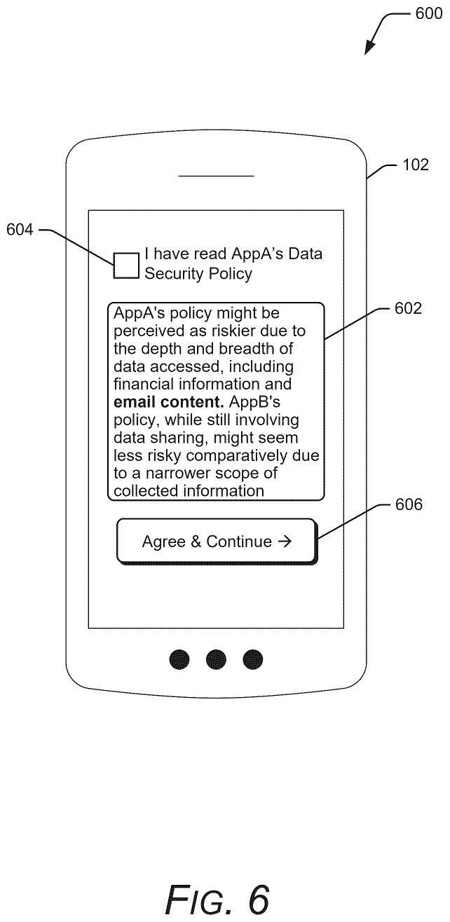

FIG. 6 illustrates an example 600 of an alert in accordance with aspects of the present disclosure. The example 600 illustrates an alert 602 displayed on an electronic device 102 that indicates the differences and/or similarities between the privacy policies of the target application and the at least one additional application. Also illustrated is a check box 604 that the user can select, if desired, to indicate that he or she has read the data security policy for AppA, and a button 606 that the user can select, if desired, to indicate that he or she agrees to AppA's data security policy. In one or more implementations, the button 606 is enabled in response to the user selecting check box 604, so the user is unable to install or use AppA unless the user indicates that he or she has read the data security policy for AppA.

Returning to FIG. 2, in one or more implementations, if the target application has options for selective opt in, the alert 226 includes a suggestion or recommendation to select or take options that are similar to or in sync with the privacy policies of other applications (e.g., comparable or similar applications) that the user uses (e.g., that the user has already accepted the data security policy for). This similarity in privacy policies between an additional application and an application already used by the user can be readily generated using the system 200 (e.g., by using an application that the user already uses as the target application).

Various examples are illustrated in FIGS. 3, 4, and 5. In one or more implementations, the information displayed in these examples in FIGS. 3, 4, and 5 is not displayed to the user. Rather, the information is used by the system 200 to generate the alert. Additionally, or alternatively, the information displayed in these examples in FIGS. 3, 4, and 5 is displayed to the users.

In one or more implementations, whether the system 200 operates to generate and display the alert is a user selectable preference. Accordingly, the user of the electronic device 102 can provide input (e.g., in response to a user prompt) to the electronic device 102 specifying whether the system 200 is to display alerts for target applications (e.g., new applications to be downloaded to or installed on the electronic device 102). The system 200 can have a default setting, such as to display alerts for target applications by default unless user input is received indicating not to display alerts for target applications.

Similarly, whether the system 200 operates to display the information in the examples of FIGS. 3, 4, and 5 is a user selectable preference. Accordingly, the user of the electronic device 102 can provide input to the electronic device 102 specifying whether the system 200 is to display the information in the examples of FIGS. 3, 4, and 5. The system 200 can have a default setting, such as to display the information in the examples of FIGS. 3, 4, and 5 by default unless user input is received indicating not to display the information in the examples of FIGS. 3, 4, and 5.

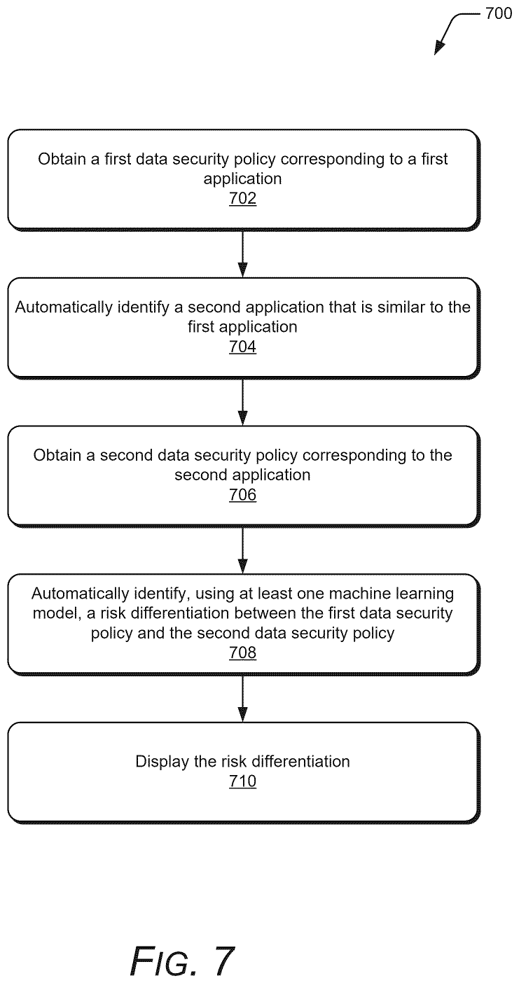

FIG. 7 illustrates a flow chart depicting an example method 700 for performing the techniques discussed herein.

At 702, a first data security policy corresponding to a first application is obtained. The first data security policy, also referred to as a first privacy policy, describes various privacy protection policies used by the first application, such as the type of data collected by the first application, how the data is collected by the first application, how the data is used by the first application, how long data will be stored by the first application, information about tracking performed by the target application, a confirmation that any third-party service providers (such as analytical or marketing tools) will provide accurate protection of users' data, and the like.

At 704, a second application that is similar to the first application is automatically identified. Two applications being similar refers to, for example, the first and second applications performing the same functionality (e.g., digital payment applications, mapping applications, texting applications, image capture or editing applications, and so forth), being downloaded from or hosted in the same region or country (e.g., England, Europe, China, and so forth), and the like.

At 706, a second data security policy corresponding to the second application is obtained. The second data security policy, also referred to as a second privacy policy, describes various privacy protection policies used by the second application, such as the type of data collected by the second application, how the data is collected by the second application, how the data is used by the second application, how long data will be stored by the second application, information about tracking performed by the target application, a confirmation that any third-party service providers (such as analytical or marketing tools) will provide accurate protection of users' data, and the like.

At 708, using at least one machine learning model, a risk differentiation between the first data security policy and the second data security policy is automatically identified. The risk differentiation is an indication of the risk of the first application relative to the second application. At 710, the risk differentiation is displayed or otherwise presented.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, FPGAs, ASICs, ASSPs, SoCs, CPLDs, and the like. The order in which the methods are described is not intended to be construed as a limitation, and any number or combination of the described method operations can be performed in any order to perform a method, or an alternate method.

FIG. 8 illustrates various components of an example electronic device that can implement embodiments of the techniques discussed herein. The electronic device 800 can be implemented as any of the devices described with reference to the previous Figures, such as any type of client device, mobile phone, tablet, computing, communication, entertainment, gaming, media playback, or other type of electronic device. In one or more embodiments the electronic device 800 includes the application detector 114, the data extractor 116, and the data summarizer 118, described above.

The electronic device 800 includes one or more data input components 802 via which any type of data, media content, or inputs can be received such as user-selectable inputs, messages, music, television content, recorded video content, and any other type of text, audio, video, or image data received from any content or data source. The data input components 802 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 802 may also include various other input components such as microphones, touch sensors, touchscreens, keyboards, and so forth.

The device 800 includes communication transceivers 804 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 800 includes a processing system 806 of one or more processors (e.g., any of microprocessors, controllers, and the like) or a processor and memory system implemented as a system-on-chip (SoC) that processes computer-executable instructions. The processing system 806 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 808. The device 800 may further include any type of a system bus or other data and command transfer system that couples the various components within the device. A system bus can include any one or combination of different bus structures and architectures, as well as control and data lines.

The device 800 also includes computer-readable storage memory devices 810 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 810 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 800 may also include a mass storage media device.

The computer-readable storage memory device 810 provides data storage mechanisms to store the device data 812, other types of information or data, and various device applications 814 (e.g., software applications). For example, an operating system 816 can be maintained as software instructions with a memory device and executed by the processing system 806 to cause the processing system 806 to perform various acts. The device applications 814 may also include a device manager, such as any form of a control application, software application, signal-processing and control module, code that is native to a particular device, a hardware abstraction layer for a particular device, and so on.

The device 800 can also include one or more device sensors 818, such as any one or more of an ambient light sensor, a proximity sensor, a touch sensor, an infrared (IR) sensor, accelerometer, gyroscope, thermal sensor, audio sensor (e.g., microphone), and the like. The device 800 can also include one or more power sources 820, such as when the device 800 is implemented as a mobile device. The power sources 820 may include a charging or power system, and can be implemented as a flexible strip battery, a rechargeable battery, a charged super-capacitor, or any other type of active or passive power source.

The device 800 additionally includes an audio or video processing system 822 that generates one or both of audio data for an audio system 824 and display data for a display system 826. In accordance with some embodiments, the audio/video processing system 822 is configured to receive call audio data from the transceiver 804 and communicate the call audio data to the audio system 824 for playback at the device 800. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

In the discussions herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Although embodiments of techniques for automated data security identification have been described in language specific to features or methods, the subject of the appended claims is not necessarily limited to the specific features or methods described. Rather, the specific features and methods are disclosed as example implementations of techniques for implementing automated data security identification. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to an electronic device including: at least one memory; and at least one processor coupled with the at least one memory and configured to cause the electronic device to: obtain a first data security policy corresponding to a first application; automatically identify a second application that is similar to the first application; obtain a second data security policy corresponding to the second application; automatically identify, using at least one machine learning model, a risk differentiation between the first data security policy and the second data security policy; display the risk differentiation.

In some aspects, the techniques described herein relate to an electronic device, wherein the first data security policy includes one or more of an indication of a type of data collected by the first application, an indication of how the data is collected by the first application, an indication of how the data is used by the first application, an indication of how long data will be stored by the first application, or an indication of information about tracking performed by the first application, a confirmation that any third-party service providers will provide accurate protection of the data.

In some aspects, the techniques described herein relate to an electronic device, wherein the at least one processor is configured to cause the electronic device to: display a user prompt requesting user input specifying whether to display alerts for new applications; and display the risk differentiation in response to the user input indicating to display alerts for new applications.

In some aspects, the techniques described herein relate to an electronic device, wherein the second application includes an application previously used by a user of the electronic device, and wherein the second data security policy was previously accepted by the user.

In some aspects, the techniques described herein relate to an electronic device, wherein the at least one processor is configured to cause the electronic device to: obtain the first data security policy and automatically identify the second application in response to a user request to install or use the first application.

In some aspects, the techniques described herein relate to an electronic device, wherein the first application includes an application downloaded to the electronic device or a web service running on a remote device.

In some aspects, the techniques described herein relate to an electronic device, wherein the at least one machine learning model includes a first machine learning model trained to generate a data security policy summarization for an application, and wherein the at least one processor is configured to cause the electronic device to: use the first machine learning model to identify a first data security policy summarization of the first data security policy; and use the first machine learning model to identify a second data security policy summarization of the second data security policy.

In some aspects, the techniques described herein relate to an electronic device, wherein the at least one machine learning model includes a second machine learning model trained to determine at least one difference between two generate data security policies, and wherein the at least one processor is configured to cause the electronic device to: use the second machine learning model to identify at least one difference between the first data security policy and the second data security policy.

In some aspects, the techniques described herein relate to a method performed by an electronic device, the method including: obtaining a first data security policy corresponding to a first application; automatically identifying a second application that is similar to the first application; obtaining a second data security policy corresponding to the second application; automatically identifying, using at least one machine learning model, a risk differentiation between the first data security policy and the second data security policy; and displaying the risk differentiation.

In some aspects, the techniques described herein relate to a method, wherein the first data security policy includes one or more of an indication of a type of data collected by the first application, an indication of how the data is collected by the first application, an indication of how the data is used by the first application, an indication of how long data will be stored by the first application, or an indication of information about tracking performed by the first application, a confirmation that any third-party service providers will provide accurate protection of the data.

In some aspects, the techniques described herein relate to a method, further including: displaying a user prompt requesting user input specifying whether to display alerts for new applications; and displaying the risk differentiation in response to the user input indicating to display alerts for new applications.

In some aspects, the techniques described herein relate to a method, wherein the second application includes an application previously used by a user of the electronic device, and wherein the second data security policy was previously accepted by the user.

In some aspects, the techniques described herein relate to a method, further including: obtaining the first data security policy and automatically identify the second application in response to a user request to install or use the first application.

In some aspects, the techniques described herein relate to a method, wherein the first application includes an application downloaded to the electronic device or a web service running on a remote device.

In some aspects, the techniques described herein relate to a method, wherein the at least one machine learning model includes a first machine learning model trained to generate a data security policy summarization for an application, and further including: using the first machine learning model to identify a first data security policy summarization of the first data security policy; and using the first machine learning model to identify a second data security policy summarization of the second data security policy.

In some aspects, the techniques described herein relate to a method, wherein the at least one machine learning model includes a second machine learning model trained to determine at least one difference between two generate data security policies, and further including: using the second machine learning model to identify at least one difference between the first data security policy and the second data security policy.

In some aspects, the techniques described herein relate to a system including: at least one memory; and at least one processor coupled with the at least one memory and configured to cause the system to: obtain a first data security policy corresponding to a first application; automatically identify a second application having similar functionality as the first application and a second data security policy previously accepted by a user of the system; obtain the second data security policy; automatically identify, using at least one machine learning model, a risk differentiation between the first data security policy and the second data security policy; display the risk differentiation.

In some aspects, the techniques described herein relate to a system, wherein the first data security policy includes one or more of an indication of a type of data collected by the first application, an indication of how the data is collected by the first application, an indication of how the data is used by the first application, an indication of how long data will be stored by the first application, or an indication of information about tracking performed by the first application, a confirmation that any third-party service providers will provide accurate protection of the data.

In some aspects, the techniques described herein relate to a system, wherein the at least one machine learning model includes a first machine learning model trained to generate a data security policy summarization for an application, and wherein the at least one processor is configured to cause the system to: use the first machine learning model to identify a first data security policy summarization of the first data security policy; and use the first machine learning model to identify a second data security policy summarization of the second data security policy.

In some aspects, the techniques described herein relate to a system, wherein the at least one machine learning model includes a second machine learning model trained to determine at least one difference between two generate data security policies, and wherein the at least one processor is configured to cause the system to: use the second machine learning model to identify at least one difference between the first data security policy and the second data security policy.

What is claimed is:

1. An electronic device comprising:
at least one memory; and
at least one processor coupled with the at least one memory and configured to cause the electronic device to:
obtain a first data security policy corresponding to a first application;
automatically identify a second application that is similar to the first application;
obtain a second data security policy corresponding to the second application;
automatically identify, using at least one machine learning model, a risk differentiation between the first data security policy and the second data security policy;
display the risk differentiation.

2. The electronic device of claim 1, wherein the first data security policy comprises one or more of an indication of a type of data collected by the first application, an indication of how the data is collected by the first application, an indication of how the data is used by the first application, an indication of how long data will be stored by the first application, or an indication of information about tracking performed by the first application, a confirmation that any third-party service providers will provide accurate protection of the data.

3. The electronic device of claim 1, wherein the at least one processor is configured to cause the electronic device to:
display a user prompt requesting user input specifying whether to display alerts for new applications; and
display the risk differentiation in response to the user input indicating to display alerts for new applications.

4. The electronic device of claim 1, wherein the second application comprises an application previously used by a user of the electronic device, and wherein the second data security policy was previously accepted by the user.

5. The electronic device of claim 1, wherein the at least one processor is configured to cause the electronic device to:
obtain the first data security policy and automatically identify the second application in response to a user request to install or use the first application.

6. The electronic device of claim 1, wherein the first application comprises an application downloaded to the electronic device or a web service running on a remote device.

7. The electronic device of claim 1, wherein the at least one machine learning model includes a first machine learning model trained to generate a data security policy summarization for an application, and wherein the at least one processor is configured to cause the electronic device to:
use the first machine learning model to identify a first data security policy summarization of the first data security policy; and
use the first machine learning model to identify a second data security policy summarization of the second data security policy.

8. The electronic device of claim 7, wherein the at least one machine learning model includes a second machine learning model trained to determine at least one difference between two generated data security policies, and wherein the at least one processor is configured to cause the electronic device to:
use the second machine learning model to identify at least one difference between the first data security policy and the second data security policy.

9. A method performed by an electronic device, the method comprising:
obtaining a first data security policy corresponding to a first application;
automatically identifying a second application that is similar to the first application;
obtaining a second data security policy corresponding to the second application;
automatically identifying, using at least one machine learning model, a risk differentiation between the first data security policy and the second data security policy; and
displaying the risk differentiation.

10. The method of claim 9, wherein the first data security policy comprises one or more of an indication of a type of data collected by the first application, an indication of how the data is collected by the first application, an indication of how the data is used by the first application, an indication of how long data will be stored by the first application, or an indication of information about tracking performed by the first application, a confirmation that any third-party service providers will provide accurate protection of the data.

11. The method of claim 9, further comprising:
displaying a user prompt requesting user input specifying whether to display alerts for new applications; and
displaying the risk differentiation in response to the user input indicating to display alerts for new applications.

12. The method of claim 9, wherein the second application comprises an application previously used by a user of the electronic device, and wherein the second data security policy was previously accepted by the user.

13. The method of claim 9, further comprising:
obtaining the first data security policy and automatically identify the second application in response to a user request to install or use the first application.

14. The method of claim 9, wherein the first application comprises an application downloaded to the electronic device or a web service running on a remote device.

15. The method of claim 9, wherein the at least one machine learning model includes a first machine learning model trained to generate a data security policy summarization for an application, and further comprising:
using the first machine learning model to identify a first data security policy summarization of the first data security policy; and
using the first machine learning model to identify a second data security policy summarization of the second data security policy.

16. The method of claim 15, wherein the at least one machine learning model includes a second machine learning model trained to determine at least one difference between two generated data security policies, and further comprising:
using the second machine learning model to identify at least one difference between the first data security policy and the second data security policy.

17. A system comprising:
at least one memory; and
at least one processor coupled with the at least one memory and configured to cause the system to:
obtain a first data security policy corresponding to a first application;
automatically identify a second application having similar functionality as the first application and a second data security policy previously accepted by a user of the system;
obtain the second data security policy;
automatically identify, using at least one machine learning model, a risk differentiation between the first data security policy and the second data security policy;
display the risk differentiation.

18. The system of claim 17, wherein the first data security policy comprises one or more of an indication of a type of data collected by the first application, an indication of how the data is collected by the first application, an indication of how the data is used by the first application, an indication of how long data will be stored by the first application, or an indication of information about tracking performed by the first application, a confirmation that any third-party service providers will provide accurate protection of the data.

19. The system of claim 17, wherein the at least one machine learning model includes a first machine learning model trained to generate a data security policy summarization for an application, and wherein the at least one processor is configured to cause the system to:
use the first machine learning model to identify a first data security policy summarization of the first data security policy; and
use the first machine learning model to identify a second data security policy summarization of the second data security policy.

20. The system of claim 19, wherein the at least one machine learning model includes a second machine learning model trained to determine at least one difference between two generated data security policies, and wherein the at least one processor is configured to cause the system to:
use the second machine learning model to identify at least one difference between the first data security policy and the second data security policy.
